(19) United States
(12) Patent Application Publication
(10) Pub. No.: US 2007/0116814 A1
(43) Pub. Date: May 24, 2007

(54) Roasting method and roasting facility for sesame seeds

(76) Inventor: Tsunekazu Shirataka, Kure-city (JP)

Correspondence Address: Tsunekazu SHIRATAKA, Hirokoshingai 7-2-23, Kure-city Hiroshima-prefecture, JP

(21) Appl. No.: 11/281,862

(22) Filed: Nov. 18, 2005

(51) Int. Cl. A23C 3/00

(52) U.S. Cl. 426/523

(57) ABSTRACT

To manufacture roasted sesame seeds (edible food) having a good fragrance by roasting sesame seeds, and to manufacture sesame seed oil by squeezing with a press sesame seeds that have been roasted at a high temperature. A roasting method comprising a material feeding step, a roasting step, and an exhaust gas treatment step; and a roasting facility thereof, comprising a roaster, a deodorizing hot-air generating furnace, a transport conveyor, a dust collector, an exhaust fan, etc., and a mechanism for feeding the high-temperature exhaust gas after deodorizing to a jacket of the roaster, for reuse as heat-exchange and/or roasting heat source, and for discharging the exhaust gas into the atmosphere via the dust collector and the exhaust fan.

### DETAILED DESCRIPTION OF THE INVENTION

1. Field of Industrial Application

The present invention relates to a roasting method and a roasting facility for roasting sesame seeds for use in roasted sesame seeds or oil extraction, the roasting facility being of indirect-heating type using heat-recovery and/or reused energy.

2. Prior Art

Sesame seeds are roasted conventionally by feeding a raw material (sesame seeds) into a rotary kiln that runs through a tunnel-type furnace covered with refractory lining, such that roasting is carried out through heating of the kiln by regulating the thermal power of burners provided at several burner openings located on both sides of the furnace.

In such a roasting method and roasting facility, the main body of the roaster runs through the furnace and is located thus inside a heat-storing furnace; in consequence, if the rotation of the kiln is stopped owing to a power outage or the like, the kiln becomes heated by the accumulated heat in the furnace, which might cause the sesame seeds contained in the kiln to catch fire and burn, damaging thereby the main body of the roaster (kiln).

Moreover, the gas generated during roasting is highly foul smelling, and constitutes an environmental issue.

Malodorous emissions are nowadays a social and industrial problem that requires stringent non-polluting measures such as incineration treatments or the like; among numerous measures proposed for dealing with the above issue are several schemes put forward by the applicants of the present invention. These include an incineration treatment that affords energy saving, treated material stabilization, resource recovery, etc. (Japanese Patent H03-353412).

### PROBLEM TO BE SOLVED BY THE INVENTION

In this context, the present inventors found out that by controlling more actively several processing steps in traditional processes such as incineration, etc., it becomes possible to handle new treatment materials, specifically, it becomes possible to roast raw-material sesame seeds, to deodorize gases generated thereby, and to recover high-temperature exhaust gases therefrom that can be reused or for developing new applications.

Moreover, this field welcomes new proposals for active resource recovery, such as non-polluting roasting of sesame seeds and more effective energy conservation than in conventional art.

In light of the foregoing, and in order to solve the above problems, it is an object of the present invention to provide a roasting method and a roasting facility for roasting sesame seeds through roasting of raw-material sesame seeds, as an attempt to develop new applications in facilities for manufacturing roasted sesame seeds having excellent fragrance.

### MEANS FOR SOLVING THE PROBLEM

In order to attain the above goals, a first invention is a method for roasting raw-material sesame seeds through indirect heating by high-temperature gas that passes through a jacket of a roaster, wherein determined quantities of raw-material sesame seeds are fed into the roaster and are roasted. The gas generated thereupon is deodorized and the heat thereof is recovered to be used as a roasting heat source.

That is, the above process comprises a material feeding step, a roasting step, and a gas treatment step.

A second invention is a roasting facility for roasting raw-material sesame seeds, comprising roasting means for roasting raw-material sesame seeds, deodorizing treatment means into which is led gas generated in the meantime, and a mechanism for feeding high-temperature exhaust gas from the deodorizing means to the roasting means, for heat-exchange and reuse, and for guiding the exhaust gas to exhaust-gas treatment means and discharging the exhaust gas into the atmosphere via ventilation means.

In the above roasting facility of the invention (second), the raw-material sesame seeds are roasted by the roasting means through indirect heating by a high-temperature gas. This operation is carried out under a pre-established temperature control.

The gases generated herein are foul-smelling gases, the malodorous component whereof is decomposed by high-temperature combustion in the deodorizing treatment means.

The deodorized high-temperature exhaust gas (hereinafter deodorized exhaust gas) is carried to the roasting means where it is used as a heat source. The deodorized exhaust gas is then sent to the exhaust gas treatment means, and is discharged into the atmosphere via the ventilation means.

### EXAMPLES

The present invention will be better understood based on the following explanation of an example of the invention (mainly the second invention) while referring to accompanying drawings. The example below is merely a concrete example of the invention, and is in no way meant to limit the technical scope of the present invention in any way.

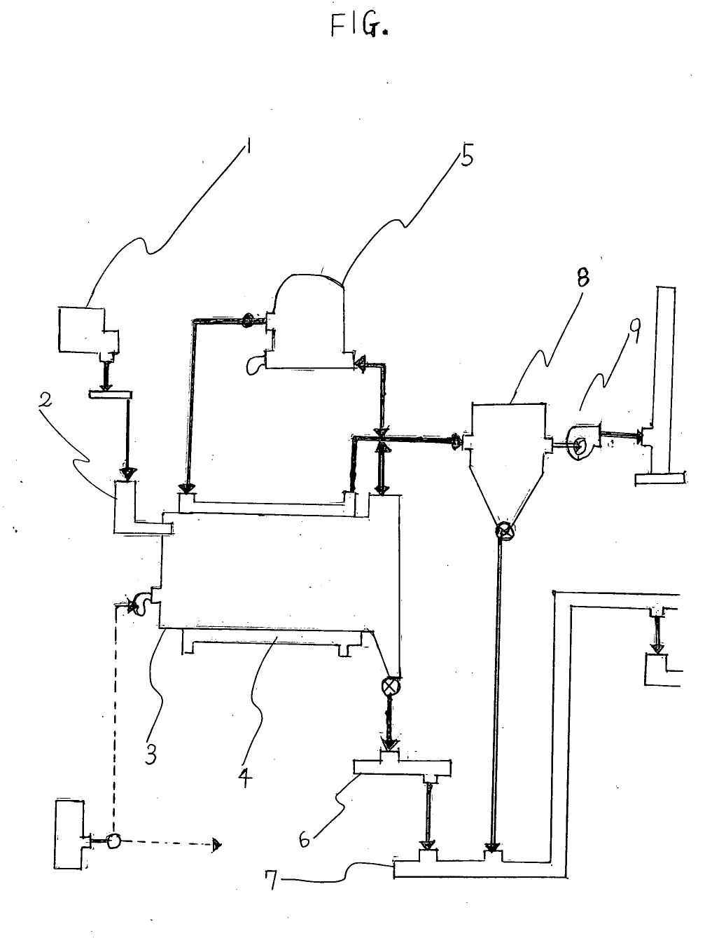

FIG. 1 is a flow sheet illustrating the roasting facility according to the present invention.

In the figure, [symbol] (heavy line) denotes a raw material line, [symbol] (double line) denotes an exhaust gas line, and - - - (broken line) denotes an oil line.

In the figure, raw-material sesame seeds are fed into a roaster (3) from a raw-material feeder (1) via a raw-material conveyor and a feeding screw (2), as indicated by [symbol] (heavy line).

The raw-material sesame seeds thus fed are roasted through indirect heating by high-temperature gas passing through a jacket (4) inside the roaster (3). The gas generated in the meantime is led through piping to a deodorizing furnace (5) where it is deodorized at high temperature by a burner.

During running, suitable temperatures, at which the various processes being carried out inside the body of the roaster (3) and in the deodorizing furnace (5) are controlled, are, as a guide, 230° C.±20° C. for the gas temperature of the generated gas outside the cylinder (point A in the figure), and at least 750° C. for the deodorized exhaust gas temperature (point B in the figure).

As indicated by [symbol] (double line), the deodorized exhaust gas is led into the jacket (4) of the roaster (3), to be reused as a source of heat, and is also led to a dust collector (8), from which it is then discharged through a chimney into the atmosphere, by way of an exhaust fan (9).

Having passed through the above process, the roasted sesame seeds are discharged into, and transferred by, a transport conveyor (7) to be conveyed to a sorting and packaging operation and/or an oil-press oil extraction operation.

### DETAILED DESCRIPTION OF THE DRAWINGS

FIG. 1 is a flow sheet illustrating a roasting facility according to the present invention.

### DESCRIPTION OF THE REFERENCE NUMERALS

1. Raw-material feeder

2. Feeding screw

3. Roaster (roasting means)

4. Jacket

5. Deodorizing furnace (deodorizing treatment means)

6. Discharge screw

7. Transport conveyor (conveying means)

8. Dust collector (exhaust gas treatment means)

9. Exhaust fan (ventilation means)

What I claim is:

1. A method for roasting sesame seeds for roasted sesame seeds/oil extraction, comprising the steps. Of:
feeding sesame seeds into a roaster; and
roasting the sesame seeds through indirect heating by a high-temperature gas that passes through a jacket of the roaster, wherein
malodorous gas generated upon roasting is deodorized and heat-recovered, and the roasting temperature can be freely adjusted.

2. A sesame seed roasting facility for roasted sesame seeds/oil extraction, comprising:
means for roasting sesame seeds;
deodorizing treatment means into which is led gas generated in the meantime; and
a mechanism for feeding high-temperature exhaust gas from the deodorizing means to the roasting means, for heat-exchange and reuse, and for guiding the exhaust gas to exhaust-gas treatment means and discharging the exhaust gas into the atmosphere via ventilation means.

3. A sesame seed roasting facility for roasted sesame seeds/oil extraction, comprising means for roasting sesame seeds, and a mechanism for, when the gas generated in the meantime requires no deodorizing treatment, roasting the sesame seeds by feeding high-temperature exhaust gas from a hot-air generating furnace to the roasting means, and for guiding the exhaust gas to exhaust-gas treatment means and discharging the exhaust gas together with the gas generated during roasting the sesame seeds into the atmosphere via ventilation means.
